(19) United States
(12) Patent Application Publication
(10) Pub. No.: US 2006/0277028 A1
(43) Pub. Date: Dec. 7, 2006

(54) Training a statistical parser on noisy data by filtering

(75) Inventors: John T. Chen, Beijing (CN); Jinjing Jiang, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/142,703

(22) Filed: Jun. 1, 2005

(51) Int. Cl. G06F 17/28

(52) U.S. Cl. 704/4

(57) ABSTRACT

A filtering or identifying approach is disclosed and applied to the task of unsupervised adaptation of a parsing model to a selected domain. In particular, unannotated text data from the selected domain is parsed using a first parser. A subset of the parsed text is then selected and used to train an improved model using a training module which can be of the type that outputs a parsing model that is usable by the first parser or can be of the type that outputs a parsing model that is usable by another type of parser.

### BACKGROUND

The discussion below is merely provided for general background information and is not intended to be used as an aid in determining the scope of the claimed subject matter.

Data-driven models for natural language parsing are among those with the highest accuracy. However, such systems typically require a large amount of hand-annotated training data that is in the same domain as the target application. This approach may be termed as supervised parser adaptation. It is costly and time-consuming. Consequently, other approaches have been explored, including unsupervised and partially supervised approaches.

In unsupervised parser adaptation, a parser trained in one domain is used to parse raw text in the target domain, and the resulting parses are used as training data. However, since the resulting training data includes irregularities due to the unsupervised nature of the technique, the new parsing model generated from the training data is less than optimal.

A number of partially supervised approaches have also been advanced. In one technique, active learning is provided where feedback from the current parsing model is used to determine which subset of unannotated sentences, if annotated by a human, would be most likely to increase the accuracy of the parser. This method can be enhanced by using an ensemble of classifiers or by selecting the most representative samples of unannotated sentences, determined by clustering the parsing model's output. In another method, a variant of the inside-outside algorithm is used with in-domain constituent information that is partially specified by a human.

Aside from these approaches, there exist others that attempt to leverage an already-existing manually annotated treebank in order to train a parser that parses either with a different style of linguistic annotation or in a different domain. One technique leverages information from treebanks annotated with a simple grammar, which are available in abundance, in order to produce models for more complex grammars. Others have tried leveraging an out-of-domain treebank in order to train an in-domain parser. One method to do this is to combine this treebank with a relatively small manually annotated in-domain treebank, and use the combination as training data for the parser. For example, by using maximum a posteriori estimation (MAP) in order to do the combination, others have achieved increases in parser accuracy.

There also exists an unsupervised variation of this last approach. An in-domain treebank is obtained in an unsupervised manner by using an out-of-domain parser to parse in-domain text. The resulting in-domain parses can be combined with out-of-domain hand checked data using MAP with a resulting increase in parsing accuracy.

This is clearly advantageous in terms of savings of human labor, but suffers in comparison with the supervised approach. Specifically, this approach suffers in two ways: training on such data leads to a model that is not as accurate, and typically a very large amount of data is needed to gain substantial improvements.

Another approach, called co-training, is used to create an accurate parser given that only a small amount of manually annotated treebank is available. This approach assumes the existence of a manually annotated treebank, a pool of raw text, and two different kinds of parsers, parser A and parser B. From this, a pool of training data is initially set to be the manually annotated treebank. Parser A is trained on the pool of training data and then parses the pool of raw text. A selection process extracts a subset of the resulting automatically parsed text. This is placed in the pool of training data, and the corresponding sentences are removed from the pool of raw text. In the next iteration, this procedure is repeated with parser B being used instead of parser A, eventually providing parser A with a larger pool of training data. In subsequent iterations, the procedure is iterated again and again with parser A and B alternating. The goal of co-training is not to increase parser accuracy across different domains (parser adaptation), but is specifically to increase parser accuracy in a given domain. As noted above, two parsers are used. However, because two parsers are required, the selection process has a different goal and can take different forms.

### SUMMARY

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

A filtering or identifying approach is disclosed and applied to the task of unsupervised adaptation of a parsing model to a selected domain. In particular, unannotated text data from the selected domain is parsed using a parser. A subset of the parsed text is then selected and used to train an improved model using a training module, which can be one that is used to train an identical or different parser.

In one embodiment, selection is performed by first ranking the parsed text based on a selected function, and then training the parsing model based on only the highest ranked data. In this embodiment, the data is a set of parse trees, where each parse tree is represented as a dependency tree corresponding to a particular sentence. In turn, each dependency tree is a set of word pairs where each word pair is a pair of words in the sentence that have some grammatical relationship. Ranking can be performed either over entire parse trees or over individual word pairs. If desired, the selected subset of parsed data can be combined with data (either in-domain or out-of-domain) known to be accurate (the combination being achieved, for example, using standard MAP estimation) in order to train the improved parsing model.

### BRIEF DESCRIPTION OF THE DRAWINGS

FIG. 1 is a block diagram of one embodiment of an environment in which the present invention can be used.

FIG. 2 is a block diagram of a system for creating training data to train a parser.

FIG. 3 is a flow chart illustrating the operation of the system shown in FIG. 2.

FIG. 4A provides a graphical illustration of Penn Treebank bracketing.

FIG. 4B illustrates a corresponding skeleton parser dependency notation for the example of FIG. 4A.

### DETAILED DESCRIPTION

One aspect relates to creating training data to train a parser. However, prior to discussing the present invention in greater detail, one illustrative environment in which the present invention can be used will be discussed.

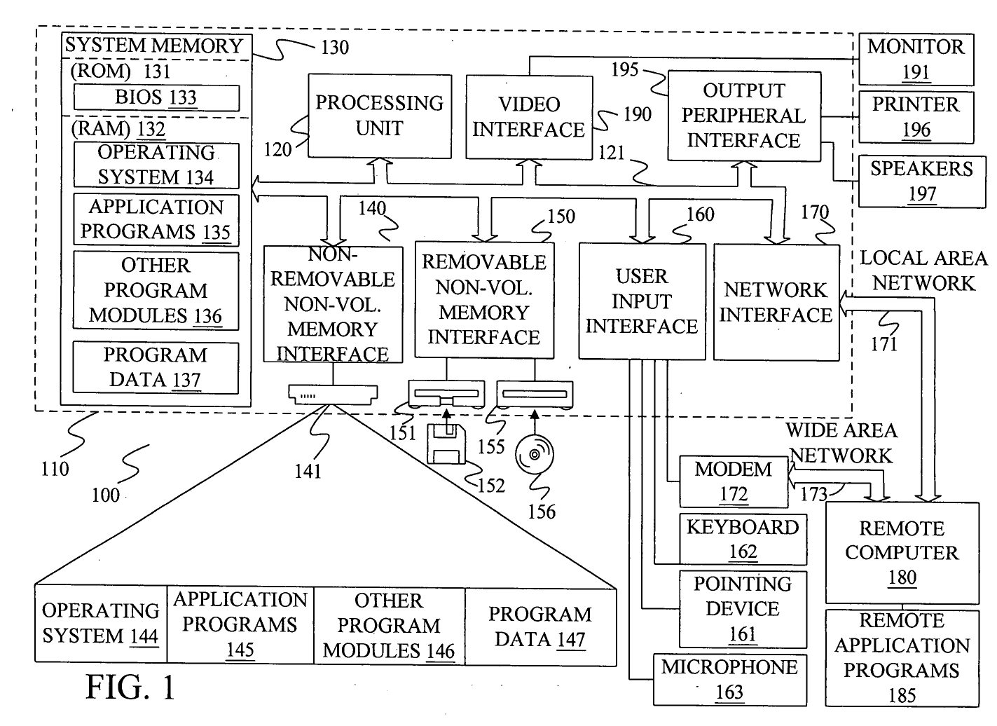

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

As indicated above, an aspect includes creating training data suitable for training a parser. Preferably, such data includes annotations that are produced by hand that aid in creating the parsing model. However, it is difficult to obtain a sufficient quantity of hand-annotated training data to train the parser.

Generally, the approach or method provided herein uses a pre-existing parser to parse raw text in the desired or target domain. The resulting parsed text serves as training data. A major problem with this approach is that because the resulting parsed text is not hand-annotated, it contains errors (noisy data), which if used to train a parser would degrade the accuracy of the model. To avoid this problem, some of the noisy data is identified and/or filtered out before parsing. By identifying and/or filtering out the noisy data, the remaining data is more effective in training an accurate parsing model. Furthermore, because some of the data is filtered out, the model is made more compact.

In the embodiment described below, the training data is ranked according to a particular function, wherein the lowest ranked data is then removed. In particular, the parsed potential training text is ranked according to a scoring function whose purpose is to rate how useful a particular example in the parsed text is to increasing the accuracy of the parser. A parser is then trained on only the highest ranked text (i.e. the most “useful” examples).

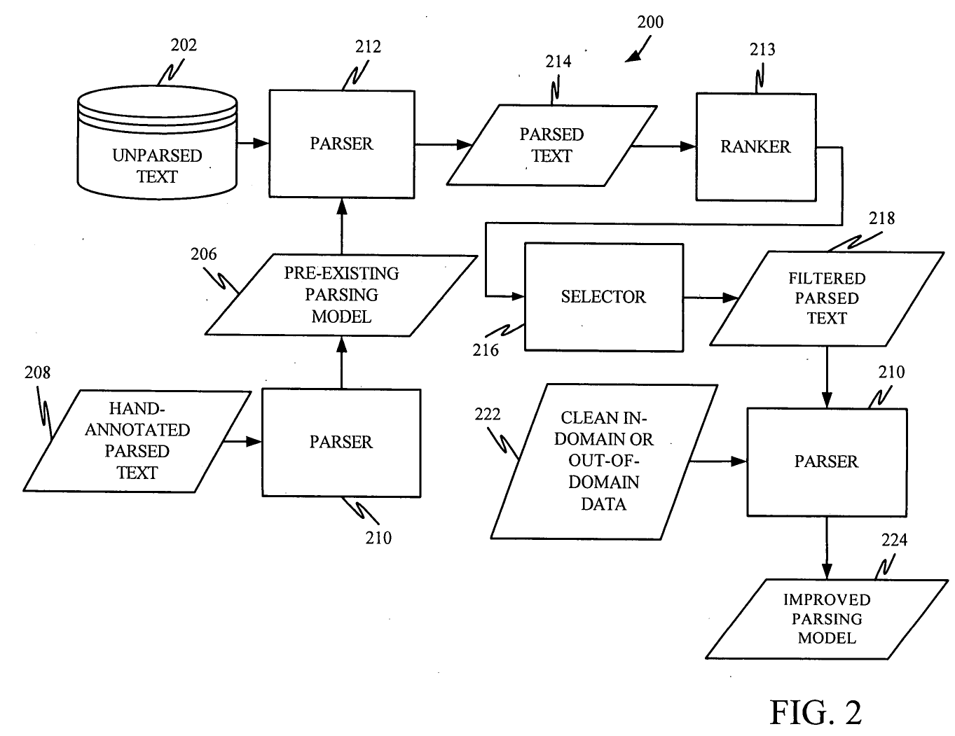

FIG. 2 is a block diagram of one embodiment of a parser training data generating system 200. System 200 has access to a corpus of raw data 202 in a desired domain. Furthermore, it can have access to a corpus 208 of hand-annotated parsed text from which a training module 210 can generate a parsing model 206. Corpus 208 may be of limited size or be in the same or different domain as the desired domain, resulting in a parsing model 206 that may be of limited accuracy or be in the same or different domain as the desired domain. One goal is to obtain a parsing model 224 that a statistical parser 226 can use to parse text in the desired domain more accurately than when parsing model 206 is used by statistical parser 212. By a statistical parser, it is meant a parser that uses probabilities as generated according to some kind of model in order to weigh output alternatives. System 200 can include training modules 210, 220, parser 212 (not necessarily trained on the same domain) , a ranker 213 and a selector 216.

In one embodiment, training module 210 and parser 212 are identical to training module 220 and parser 226. There are many different kinds of training modules and statistical parsers, however. In an alternative embodiment, 210, 212, 220, and 226 may differ. Examples of training modules include but are not limited to maximum entropy training, conditional random field training, support vector machine training, and maximum likelihood estimation training. Examples of parsers include but are not limited to statistical chart parsers and statistical shift-reduce parsers. In another embodiment, pre-existing parsing model 206 is already supplied. Therefore hand-annotated parsed text 208 and training module 210 are not used. In yet another embodiment, (statistical) parser 212 is replaced by a symbolic parser 212 whose only input is raw text 202. In this case, hand-annotated parsed text 208, training module 210, and pre-existing parsing model 206 are not used. Also, one goal is to obtain a parsing model 224 that a statistical parser 226 can use to parse text in the desired domain more accurately than when symbolic parser 212 is used.

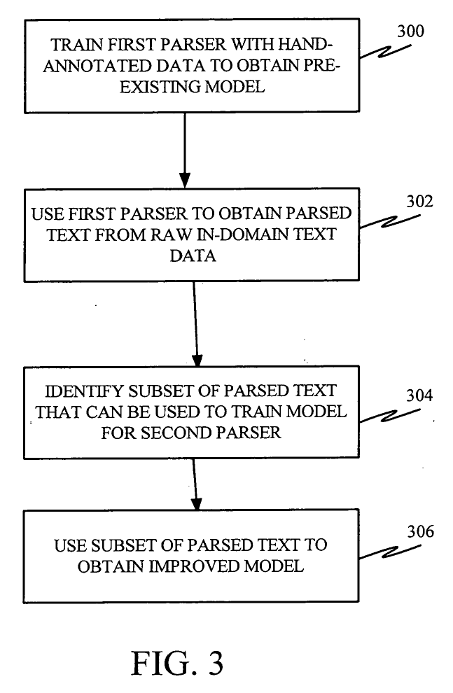

FIG. 3 is a flow diagram illustrating the operation of system 200 shown in FIG. 2. Step 300 is optional in the case where parser 212 is a symbolic parser or in the case where parser 212 is a statistical parser but a pre-existing parsing model 206 is already supplied.

At step 302, parser 212 uses model 206 to obtain parsed or annotated text 214 from the corpus of raw unannotated data 202. In particular, model 206 is used to score elements of parsed text 214. These elements include but are not limited to entire parse trees or dependency pairs of words. Elements with the highest scores are then identified, selected and used by training module 220 to create an improved parsing model 224 in the desired domain. In FIG. 3, this is illustrated at step 304, where ranker 213 receives parsed text 214 and ranks the elements of parsed text 214 explicitly or implicitly yielding ranked parsed text 215. Selector 216 then selects those elements having the highest scores, i.e. a subset of the parsed text 214 to form a corpus 218 of filtered textual items, which is then used by training module 220. As appreciated by those skilled in the art, use of ranker 213 and selector 216 is but one technique for obtaining corpus 218 from corpus 214 and the use thereof should not be considered limiting.

The scoring function used to rank the elements of parsed text can take many forms. The form that it should take can depend on the kind of training module 210 that will be trained and the kind of parser 212 that is used to annotate the unannotated data 202.

In one embodiment, training module 210 outputs a parsing model 206 that is used by parser 212, which is a statistical parser. Examples of training modules include training modules for maximum-entropy models, support-vector machines, conditional random fields, and maximum likelihood estimation. Examples of parsers include history-based parsers, statistical shift-reduce parsers, and generative-model parsers. In another embodiment, parser 212 is a symbolic parser instead of a statistical parser. Parsers also vary according to the kind of parse output that they produce. Examples of different kinds of output include dependency parses and phrase structure parses. In the exemplary embodiment described below, a parsing-model parser that outputs dependency parses is used. However, note that this is but one example, wherein the approach described herein is adaptable in a straightforward manner to other kinds of statistical parsers.

By way of example and in one embodiment, a “skeleton parser” can be used. This type of parser outputs only “skeleton relations,” which are defined as the complement relations of surface subject and surface object. Such a parser may have an advantage over others because these relations may be more important than other kinds of relations when it is necessary to find the core meaning of an input text. In addition, they may be more reliably detected than other relations, and also the parser may be more robust when switching to different domains.

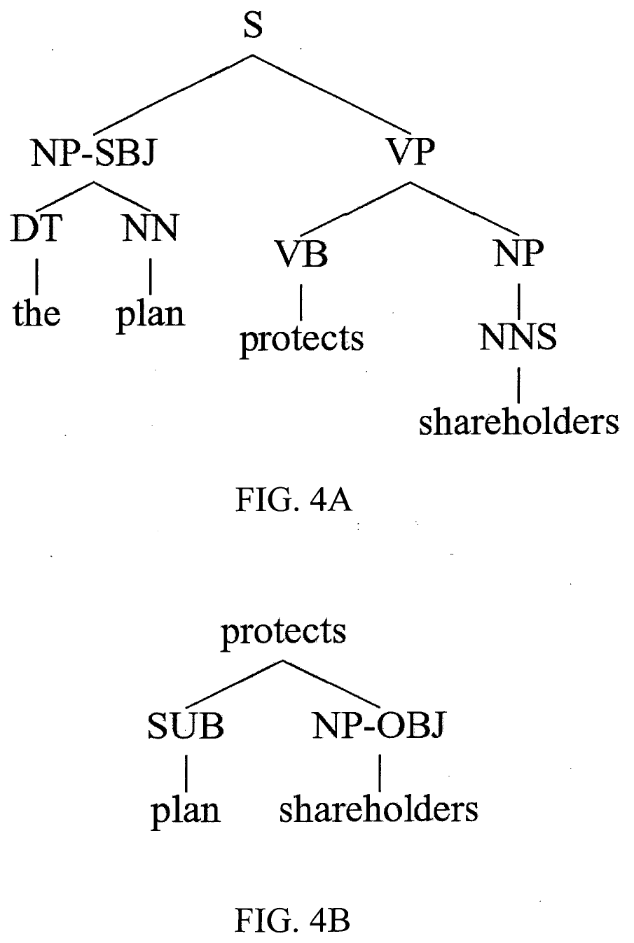

Skeleton relations can be derived using a deterministic procedure from Penn Treebank II-style bracketings such as described by Mitchell Marcus, Beatrice Santorini, and Mary Ann Marcinkiewicz, 1993, “Building a large annotated corpus of english: the penn treebank,” Computational Linguistics, 19(2) :313-330. The procedure is adapted from the one used by Michael Collins, 1996, “A new statistical parser based on bigram lexical dependencies,” In Proceedings of the 34th Annual Meeting of the Association for Computational Linguistics. FIG. 4A provides a graphical illustration for Penn Treebank bracketing of “The plan protects shareholders”, while FIG. 4B illustrates corresponding skeleton parser dependency notation for the same. The skeleton parser is similar to a grammatical relations finder along the lines of Sabine Nicole Buchholz. 2002, “Memory-Based Grammatical Relations Finding,” Ph.D. thesis, Tilburg University; and Alexander Yeh, 2000, “Comparing two trainable grammatical relations finders,” In Proceedings of the 18^{th} International Conference on Computational Linguistics (COLING 2000), pages 1146-1150, Saarbruecken, Germany. However, the skeleton parser has certain innovations that make it more resistant to noise in the training data. It is a cascaded three-stage parser where the stages are: part of speech tagging, base NP (noun phrase) chunking, and ME (maximum entropy) grammatical relations finding. The POS tagger is based on a trigram Markov model as expressed in the following equation:

$$P ( W , T ) = {\prod }_{i = 1}^{n} P ( {w}_{i} \vert {t}_{i} ) P ( {t}_{i} \vert {t}_{i - 1} {t}_{i - 2} ) \qquad ( 1 )$$

where W is the sequence of words in the input sentence and T is the corresponding sequence of POS tags. The N-best sequences from the POS tagger are passed to a base NP chunker, which is itself based on a trigram Markov model:

$$P ( N , W , T ) = P ( W , T ) {\prod }_{i = 1}^{m} P ( {w}_{i} \vert {t}_{i} {n}_{i} ) P ( {n}_{i} \vert {n}_{i - 1} {n}_{i - 2} ) \qquad ( 2 )$$

where N is a sequence of tags representing a base NP sequence. More details of these two stages are found in “A Unified Statistical Model for the Identification of English Base NP” by Endong Xun, Changning Huang, Ming Zhou, 2000, In Proceedings of ACL 2000, Hong Kong.

Word pairs (candidate word pairs) in the sentence that might possibly constitute a grammatical relation are deterministically chosen given the POS-tagged, base-NP chunked sentence. A candidate word pair consists of a head word and a focus word, corresponding to the governor and dependent of a potential relation. Finally, a ME model is used to decide whether each candidate word pair is indeed a skeleton relation and if so, what kind, according to:

$$\begin{matrix}y = {arg max}_{{y}^{′}} P ( {y}^{′} \vert x ) \\ = πμ \frac{1}{Z ( x )} {\prod }_{i = 1}^{k} {α}_{j}^{{f}_{j} ( x , {y}^{′} )}\end{matrix} \qquad ( 3 )$$

where x is the history, y is the prediction, f₁, . . . , fₖ are characteristic functions, each corresponding to a particular feature value and output, and Z is a normalization function. In this approach, x corresponds to a particular candidate word pair and y is the prediction of a skeleton relation.

In order to determine the parameters π,μ, and α₁,. . . , αₖ, GIS set up can be run for 100 iterations. A count cutoff is used whereby feature values that are seen less than five times are not included in the model.

The ME model requires a set of features in order to make a prediction about a particular candidate word pair. These features include information about the word pair themselves, words surrounding the head and focus word, and context of the sentence in between the word pair. A list of atomic features is provided below.

| Feature Name | Sample Feature Values |
|---|---|
| Direction | Left, Right |
| POS-tag-seq | VB-IN-NP, NP-NP-VBN |
| Chunk-Distance | 0, 1, 2, 3-6, 7+ |
| Intervening-verb | True, False |
| Num-interven-punc | 0, 1, . . . |
| Word | butcher, rescinded |
| Part of Speech | NN, VB |

Among these features are words and pos tags in a window around the head and focus word. Window size depends on whether the focus is left or right of the head word, as provided below.

| | | | |
|---|---|---|---|
| L. Win | R. Win | L. Win | R. Win |

| | |
|---|---|
| Left Head | Right Focus |

| | | | | |
|---|---|---|---|---|
| Word | 0 | 2 | 0 | 2 |
| POS | 3 | 1 | 3 | 1 |

| | |
|---|---|
| Left Focus | Right Head |

| | | | | |
|---|---|---|---|---|
| Word | 1 | 2 | 0 | 1 |
| POS | 2 | 0 | 1 | 0 |

Each atomic feature is conjoined with the Direction and pos tag of the focus word in order to form a composite feature. These composite features are examples of ones that can be used.

As indicated above one technique for identifying noisy v. good textual data is to filter the resulting data, one method of filtering being ranking. Below are some exemplary ranking functions that can be used. In the embodiment described below, the purpose of these functions is to rank noisy training data so that part of the data which is most useful in increasing the accuracy of the parser is ranked the highest.

There are different criteria that we can use to design a ranking function. For purposes of explanation, assume ranking is over parses of sentences in the training data.

Informativeness is one criterion for ranking; in this case, data size matters the most. For example, a longer parsed sentence should be preferred over a short one.

Accuracy is another criterion for ranking. By accuracy, what is meant is the degree of correctness of a parsed sentence. It is believed this should have some bearing on the data's usefulness in training the model.

Discrimination is yet another criterion for ranking. This criterion prefers inclusion of parsed sentences that the out-of-domain model has a difficult time parsing. Inclusion of such data may be harmful because it may be less accurate than other data, but on the other hand it may prove beneficial because the model may adapt better if it concentrates on difficult cases.

In this exemplary embodiment, ranking of training data is performed in order to train the ME component of the skeleton parser in particular. Therefore, the domain of the ranking function may not only include raw in-domain sentence text, but also pos tags and base NPs that are assigned to this text by the pos tagger and base NP chunker components of the parser, as trained on out-of-domain training data. Furthermore, information about candidate word pairs in the in-domain text can also be a part of the domain of the ranking function because it is ascertained deterministically given the preceding information. The range of the ranking function can be a real number, with higher values indicating higher rank. In this exemplary embodiment, the parses that are to be ranked are assumed to be output by a statistical parser; in this case, use of probability distributions P that are used by the statistical parser in the ranking methods can be helpful.

Here follows some terminology. Assume initially that the ranking functions take a sentence S, composed of the words in the sentence, along with their pos tags, base NPs, and consequently information about candidate word pairs. DS is the multiset of candidate word pairs in S. X(DS) is the multiset of histories where each history x that is in X(DS) corresponds to a particular candidate word pair in D(S). Let M represent the ME skeleton parsing model trained on out-of-domain data. The set of all possible predictions Y include dependency labels corresponding to subject and object. It also includes the label “None” meaning that no relation exists between the candidate word pair.

With respect to the ranking functions discussed above, the first ranking function f_{dep} corresponds to the ranking criterion of informativeness. It simply counts the number of positive instances of dependencies in S:

$${f}_{dep} ( S ) = \vert \{ x ∈ X ( {D}_{S} ) \vert None \neq arg {max}_{y ∈ Y} {P}_{M} ( y \vert x ) \} \vert \qquad ( 4 )$$

The next ranking function is f_{acc}. It represents the ranking criterion of accuracy. The proxy for quality that is used is the probability that M assigns to its prediction; the higher the probability, the more likely that the prediction is correct:

$${f}_{acc} ( S ) = \frac{{\sum }_{x ∈ X ( {D}_{S} )} {max}_{y ∈ Y} {P}_{M} ( y \vert x )}{\vert X ( {D}_{S} ) \vert} \qquad ( 5 )$$

The last ranking function exemplified herein is fₑₙₜ. It encodes the ranking criterion of discrimination, which ranks data higher if it is difficult for M to classify. One way to represent difficulty is in terms of uncertainty, which means that Fₑₙₜ can be represented by using an entropy function:

$$\begin{matrix}{f}_{ent} ( S ) = \frac{{\sum }_{x ∈ X ( {D}_{s} )} {\sum }_{y ∈ Y}^{} - {P}_{M} ( y \vert x ) log {P}_{M} ( y \vert x )}{\vert X ( {D}_{S} ) \vert} & ( 6 ) \\ {f}_{ent} ( S ) = \frac{{\sum }_{x ∈ X ( {D}_{S} )} {\sum }_{y ∈ Y} - {P}_{M} ( y \vert x ) log {P}_{M} ( y \vert x )}{\vert X ( {D}_{S} ) \vert} & ( 6 )\end{matrix}$$

As indicated above, all of these functions assume that the ranking function ranks over sentences. On one hand, this seems appropriate because the parsing model can be employed to parse entire sentences, not just parts of sentences; thus perhaps it is better to train the model on entire parses. On the other hand, it may be inappropriate because a noisy parse of a particular sentence might contain a mixture of useful and harmful data. Therefore, it should be noted that ranking can be performed over candidate word pairs instead of sentences. With respect to f_{acc} and fₑₙₜ, this can be represented as:

$${f}_{acc} ( x ) = {arg max}_{y ∈ Y} {P}_{M} ( y \vert x )$$

$${f}_{ent} ( x ) = {\sum }_{y ∈ Y} - {P}_{M} ( y \vert x ) log {P}_{M} ( y \vert x )$$

Referring back to FIG. 2, selector 216 selects the highest ranked parsed textual data from ranked parsed text 215. One technique includes tuning by testing models generated from subsets of the ranked parsed text 214 on a held-out data set. In particular, a set of models, which differ only in the percentage of highest ranked training examples that are used for training, is trained. Each model is tested on the held-out data set. The set of training examples that yields the model with the highest accuracy becomes the filtered parsed data 218 that is output by selector 216.

Use of MAP estimation has been used to combine two sets of hand annotated (clean) training data in order to train a statistical parser (e.g. as described by Brian Roark and Michiel Bacchiani, 2003, Supervised and unsupervised pcfg adaptation to novel domains, In Proceedings of the 2003 Human Language Technology Conference and Annual Meeting of the North American Chapter of the Association for Computational Linguistics (HLT-NAACL), pages 287-294, Edmonton, Canada; or Daniel Gildea, 2001, Corpus variation and parser performance, In Proceedings of the 2001 Conference on Empirical Methods in Natural Language Processing (EMNLP-01), Pittsburgh, Pa.). Both Roark and Bacchiani (2003) and Gildea (2001) use MAP estimation to combine in-domain data with out-of-domain data. Roark and Bacchiani (2003) show that MAP adaptation reduces to different methods of combination, two of which are count merging and model interpolation. In one embodiment, a simple form of count merging can be used, which amounts to concatenating the two sets of training data. Alternatives include weighting the counts of one set differently than that of the other, although it may not be immediately apparent how the weighting applies to ME modeling.

One can also use model interpolation. Let Pₒᵤₜ and Pᵢₙ be the out-of-domain and in-domain models, respectively, and INT(_{Pout}, Pᵢₙ) be the combined model. Then, model interpolation is defined as follows:
INT(Pₒᵤₜ,Pᵢₙ)(y|x)=λPₒᵤₜ(y|x)+(1−λ)Pᵢₙ(y|x) (7)
INT(Pₒᵤₜ,Pᵢₙ)(y|x)=λPₒᵤₜ(y|x)+(1−λ)Pᵢₙ(y|x)
In order to determine λ, one can use the in-domain heldout corpus.

Instead of combining two sets of clean data, MAP estimation can be used, as illustrated in FIG. 2, where training module 220 is used in order to combine in-domain filtered noisy data 218 and clean data 222 (data known to be accurate either in-domain, e.g. hand annotated text 208, or out-of-domain) to obtain the improved training model 224. There is more than one way to perform this combination, including, as described above, count merging and model interpolation.

Although the present invention has been described with reference to particular embodiments, workers skilled in the art will recognize that changes may be made in form and detail without departing from the spirit and scope of the invention.

What is claimed is:

1. A computer-implemented method of creating training data to train a parser in a selected domain, comprising:
parsing unannotated text of the selected domain using a first parser to obtain parsed text;
identifying in the parsed text a subset thereof that is more appropriate than other portions for obtaining an improved parsing model in the selected domain; and
creating the improved parsing model using the subset of parsed text and a training module.

2. The computer-implemented method of claim 1 wherein identifying comprises filtering the parsed text to obtain the subset thereof.

3. The computer-implemented method of claim 2 wherein identifying comprises using a ranking function.

4. The computer-implemented method of claim 3 wherein using a ranking function comprises using a ranking function based on informativeness of text items in the parsed text.

5. The computer-implemented method of claim 3 wherein using a ranking function comprises using a ranking function based on accuracy of text items in the parsed text.

6. The computer-implemented method of claim 3 wherein using a ranking function comprises using a ranking function based on discrimination of text items in the parsed text.

7. The computer-implemented method of claim 6 wherein wherein using a ranking function comprises using a ranking function based on uncertainty.

8. The computer-implemented method of claim 7 wherein wherein using a ranking function comprises using a ranking function based on an entropy function.

9. The computer-implemented method of claim 1 wherein at least one of parsing and identifying comprises using a pre-existing model in the selected domain.

10. The computer-implemented method of claim 5 wherein the first parser and a parser that utilizes the improved parsing model are identical.

11. The computer-implemented method of claim 3 wherein identifying comprises identifying sentences.

12. The computer-implemented method of claim 3 wherein identifying comprises identifying word pairs.

13. The computer-implemented method of claim 1 wherein creating the improved parsing model comprises using known accurate textual data in addition to the subset of parsed text.

14. The computer-implemented method of claim 11 wherein the known accurate textual data comprises data in the selected domain.

15. The computer-implemented method of claim 11 wherein the known accurate textual data comprises out-of-domain data relative to the selected domain.

16. A computer readable medium having instructions which when performed by a computer create training data for training a parser, the instructions comprising:
parsing unannotated text of the selected domain using a first parser to obtain parsed text;
ranking portions of the parsed text to identify a subset thereof that is more appropriate than other portions for obtaining an improved parsing model in the selected domain; and
creating the improved parsing model using the subset of parsed text and a training module.

17. The computer readable medium of claim 16 wherein ranking comprises using a ranking function based on informativeness of text items in the parsed text.

18. The computer readable medium of claim 16 wherein ranking comprises using a ranking function based on accuracy of text items in the parsed text.

19. The computer readable medium of claim 16 wherein ranking comprises using a ranking function based on discrimination of text items in the parsed text.

20. The computer readable medium of claim 19 wherein ranking comprises using a ranking function based on an entropy function.
